(19) United States
(12) Patent Application Publication
(10) Pub. No.: US 2023/0316347 A1
(43) Pub. Date: Oct. 5, 2023

(54) SYSTEM AND METHOD OF SELECTING JOB CANDIDATES FOR ENHANCED ACCEPT AND REJECT APPLICATIONS

(71) Applicant: Indeed, Inc., Austin, TX (US)

(72) Inventor: Zak Cocos, Austin, TX (US)

(21) Appl. No.: 18/130,159

(22) Filed: Apr. 3, 2023

Related U.S. Application Data
(60) Provisional application No. 63/326,423, filed on Apr. 1, 2022.

(51) Int. Cl. G06Q 30/0283; G06Q 10/1053

(52) U.S. Cl. CPC G06Q 30/0283; G06Q 10/1053

(57) ABSTRACT

A computer-implementable method, system and non-transitory, computer-readable storage medium for charging customers as to applicants applying to a job posting. A job site portal receives job posting from the applicants which are stored in a job application database accessed by the job site portal. Over a predetermined period of time a determination is made if a customer is interested in a job application of an applicant to the job posting and is charged if the customer is interested in the job application. A recommendation is made as to other job applications that are of interest to the customer.

### BACKGROUND OF THE INVENTION

### Field of the Invention

The present invention relates to information handling systems. More specifically, embodiments of the invention provide for machine learning, providing recommendations, and charging customers for job applications for job postings by the customers.

### Description of the Related Art

As the value and use of information continues to increase, individuals and businesses seek additional ways to process and store information. One option available to users is information handling systems. Information handling systems include personal computers (PC), server computers, such as desktops. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Through the use of information handling systems, job postings can be made available such as through an online service. The job posting can be provided by employers or customers to the service. Prospective applicants can submit applications to the job posting through information handling systems.

A service may charge customers/employers a fee every time an application by an applicant is submitted. Not all applicants meet the needs or expectations of a customer or employer. In other words, a number of applications are not accepted or are rejected. Different and multiple people apply for job postings; however, only a select number are chosen by the employer to be interviewed. The customer/employer under the per application charging pays for the submitted application, regardless of whether the applicant is accepted or not. Ideally, customers only pay for the applicants that are accepted. Furthermore, it would be desirable for customers/employers to be provided with more acceptable candidates to their job postings.

### SUMMARY OF THE INVENTION

A computer-implementable method, system and non-transitory, computer-readable storage medium for charging customers as to applicants applying to a job posting comprising receiving at a job site portal, job applications to the job posting from the applicants; storing the job applications in a job application database accessed by the job site portal; accessing from the job applications database to the job site portal the stored job applications; determining over a predetermined period of time by the job site portal if a customer is interested in a job application of an applicant to the job posting; charging by the job site portal the customer, if determined that the customer is interested in the application of the application to the job posting; and providing by a recommendation engine of the job site portal, a list of other job applications that are of interest to the customer.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a system for charging customers for job postings that are submitted and applied for by job applicants;

FIG. 2 is a user interface for a customer/employer for initially providing job applications to a job service;

FIG. 3 is a user interface for a customer/employer that starts a time period countdown to accept a job application;

FIG. 4 is a user interface for a customer/employer to reject a job application;

FIG. 5 is a user interface for a customer/employer that indicates that a job application has been rejected;

FIG. 6 is a generalized flowchart for charging customers for job applications for job postings by the customers; and

FIG. 7 is a general illustration of components of an information handling system as implemented in the present invention

### DETAILED DESCRIPTION

Various implementations of a technological system and method of accepting and replacing job applications. In at least one embodiment, the system and method provide for determining over predetermined time period, such as 48 hours (two days, if customers or employers of a service have accepted, rejected, or have not decided as to job applications that have been submitted from a job posting service. If job applications are accepted, then the customer is charged.

Implementations further provide for other job applications or candidates/applicants to the job posting to be recommended to customers based on artificial intelligence (AI) and machine learning (ML) of job candidates that have been rejected or accepted. In at least one embodiment, the AI/ML provides technology to assist with improving the functionality of the system and method of accepting and replacing job applications. The AI/ML is trained on various data, such as employer feedback and job seeker related data. Employer data includes job candidates that are accepted or rejected and information specifying reasons for acceptance or rejection. In at least one embodiment, the employer is presented with a survey after taking acceptance or rejection action towards the job candidate that present the reasons for such action. Exemplary survey action data includes the candidate had sufficient or insufficient years of experience, relevant experience, relevant education, connection to the employment location, and so forth and the accept or rejection action taken. Job candidate information includes information such as resume and application data. In at least one embodiment, the AI/ML correlates the employer survey and action data with the job candidate data to learn what kind of candidates are most likely to be accepted by the employer and then identify future candidates that have a higher probability of acceptance. In at least one embodiment, the AI/ML also correlates multiple employer survey and action data to draw inferences from one similarly situated employer to another. The criteria for similarly situated employers is a matter of design choice. For example, similarly situated employers can include employers in similar business fields, similar locations, similar size, and so on. Additionally, in at least one embodiment, the AI/ML data can assist a recommendation engine in making job candidate recommendations in near recommendation engine to make real time or near real-time recommendation changes based on candidate-to-candidate employer survey and action data and candidate data. Furthermore, the advanced accept and replace technology disclosed herein support experimenting with new and improved pricing models that benefit customers and recruiting entities more quickly.

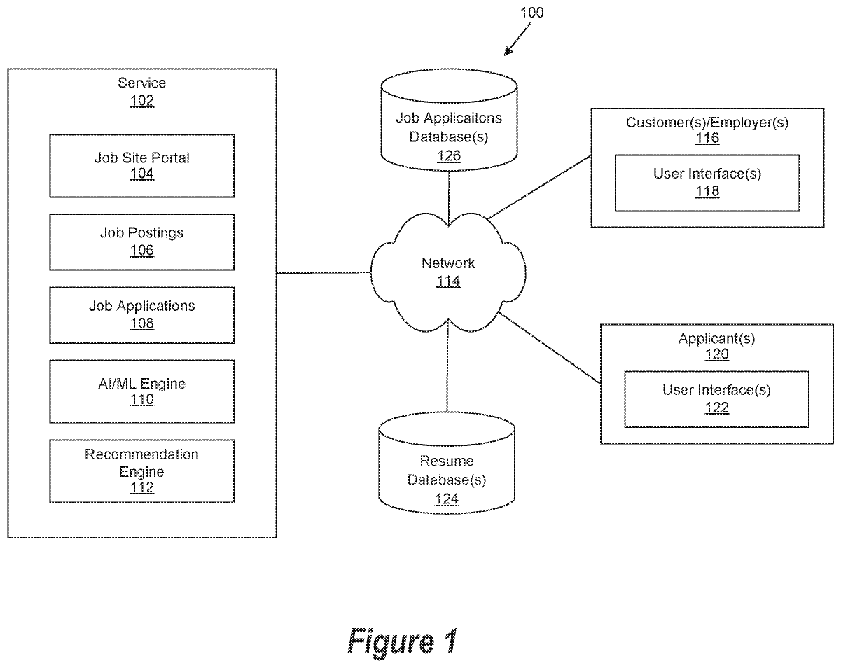

FIG. 1 shows a system 100 for charging customers for job postings that are submitted and applied for by job applicants. The system 100 includes a service 102. The service 102 is implemented as an information handling system as further described herein. The service 102 in particular provides a job posting service. Service 102 includes a job portal 104. Job postings 106 are stored at service 100 which is received by job portal 104. The service 102 further includes job applications 108 that are received by job portal 104.

In various implementations, the service 102 includes an AI/ML engine 110 that uses information from accepted and rejected job applications 108 as to specific job postings 106, and determines characteristics of job applications 108 that would be acceptable to a customer. Implementations provide for customers to provide specific answers to particular questions, where the answers can be processed by the AI/ML engine 110. Implementations provide for applying a ranking algorithm to determine customer preferences to the job application.

A recommendation engine 112 of the service 102 provides applicant or application recommendations to a customer. The recommendations is sent from the job portal 104. Recommendations may hide the names and contact information of applicants 120 to customer(s)/employer(s) 116 to avoid customer(s)/employer(s) 116 merely performing a name search to find out the applicant and contact the applicant directly.

As previously discussed, the AI/ML engine 10 analyzes employer data, such as employer survey and action data, and job candidate data to improve presentation of future job candidates to the employer and, in at least one embodiment, similarly situated employers. In at least one embodiment, for an employer, the AI/ML engine 110 provides data to the recommendation engine 112 that indicates what features of job candidate data will have a higher probability of being accepted than not accepted. The recommendation engine 112 can utilize the AI/ML engine 10 input to provide a list of candidates to the employer that are determined to be most viable for job posting 106. In addition, a list of applicants 120 can be improved. System 100 further includes a network 114 that connects the service 100. The network 140 includes one or more wired and wireless networks, including the Internet, and provide access to various sites, entities, devices, etc. of system 100. The system 100 further includes customer(s)/employer(s) 116. Customer(s)/employer(s) 116 is implemented as an information handling system as further described herein. Implementations provide for customer(s)/employer(s) 116 to provide job postings 106 to the service 102 through user interface(s) 118. The user interface(s) 118 interacts with the job site portal 104. In various implementations, user interface(s) 118 provides information and recommendations from the service 102 to customer(s)/employer(s) 116. Additionally, in at least one embodiment, the AI/ML by providing candidate selection acceptance criteria for improving candidate selection in near real-time, the AI/ML can assist the recommendation engine 112 in making job candidate recommendations in near real time or near real-time recommendation changes based on candidate-to-candidate employer survey and action data and candidate data. Furthermore, the advanced accept and replace technology disclosed herein support experimenting with new and improved pricing models that benefit customers and recruiting entities more quickly

The system 100 further includes applicant(s) 120. Applicant(s) 120 is implemented as an information handling system as further described herein. Implementations provide for applicant(s) 120 to apply to job postings 106 through user interface(s) 122. The user interface(s) 122 interacts with the job site portal 104. In various implementations, the job site portal 104 provides automated rejection notifications to applicant(s) 120 if a customer(s)/employer(s) 116 rejects their job application(s) 108. The system 100 further includes one or more resume database(s) 124. The resume database(s) 124 may or may not include resumes applicant(s) 120. Candidates of resumes of resume database(s) 124 can be asked or invited to certain job applications 106 through job site portal 106. Furthermore, customer(s)/employer(s) 116 can be advised of potential candidates to particular job applications 108.

Resumes in resume database(s) 124 can be in various formats, such as pdf, word document, etc. and have particular fields. In certain implementations, the job site portal 104 converts certain formats to include particular fields, such as “name”, “contact information”, “education”, “job title”, etc. Implementations provide for the recommendation engine to recommend particular candidates and their resumes from resume database(s) 124. Implementations provide for certain fields to be hidden, such as “name” and “contact information” to avoid customer(s)/employer(s) 116 from merely performing a name search to find out the applicant and contact the applicant directly. In various implementations, job applications 106 that are provided by applicant(s) 120 are stored in one or more job applications database(s) 126. The job site portal 104 accesses job applications 106 from the job applications database(s) 126.

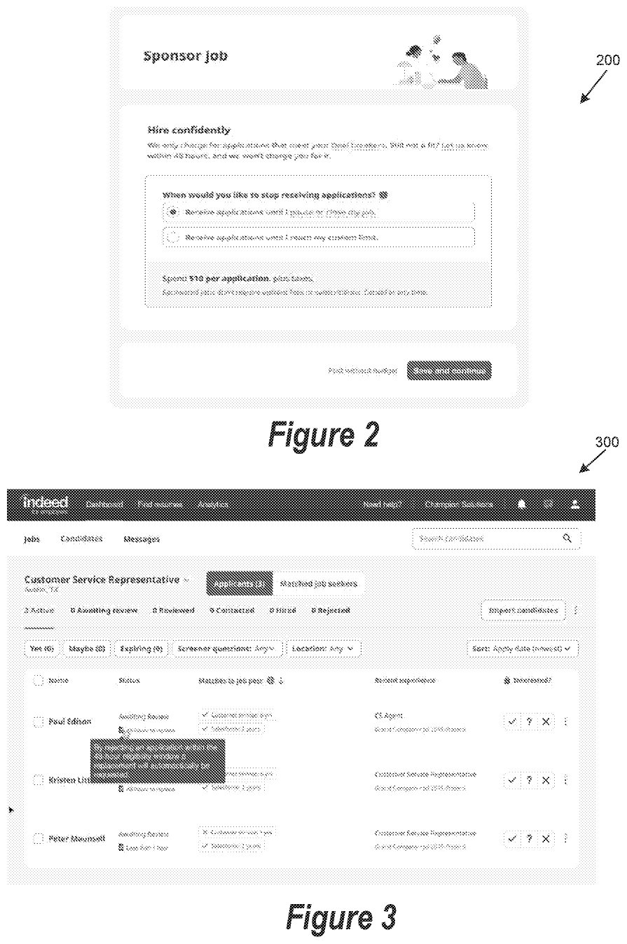

FIG. 2 shows a graphical user interface 200 for a customer/employer 116 for initially providing job applications 108 to service 102. The graphical user interface 200 is included with user interfaces 118. In certain implementations, the customer/employer 116 is provided a “sign in page”, log in procedure to get to the user interface 200. Prompts can be given to “sponsor a job”, “credit card/charging information”, etc. A tracking system with a dashboard is also an implementation.

FIG. 3 shows a graphical user interface 300 for a customer/employer 116 that starts a time period countdown to accept a job application 108. In this example the customer/employer 116 has 48 hours to accept the job application 108. The delay in the charging process is performed, such that only the applications of which customer/employer 116 is interested in is charged. An indication is waited upon that customer/employer 116 are keeping or have interest in keeping job application 108, and are interested in applicant 120. The indication can either “yes” or “maybe”. Can be an affirmative rejection or “no” to a job application 108.

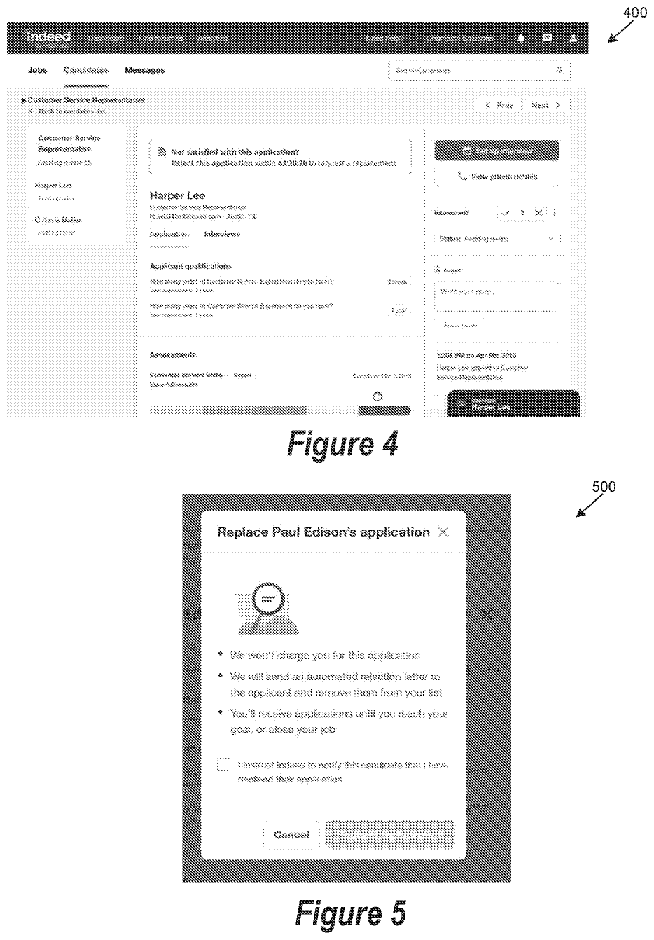

FIG. 4 is a graphical user interface 400 for a customer/employer 116 to reject a job application. In certain implementations, when a job application 108 is rejected and replacement job application is provided. The rejected job application is removed, and no charge is made to the customer/employer 116.

FIG. 5 is a graphical user interface 500 for a customer/employer 116 that indicates that a job application has been rejected. Implementations provide for a rejection letter or email to be sent to applicants 120 of rejected job application(s) 108. This avoids the customer/employer 116 from directly contacting the applicants 120 and close the loop in the process for rejected applicants 120.

In various implementations, the service 102 provides customer/employer 116 engagement with applicants 120 whose job application 108 are accepted. The job site portal 106 through user interfaces 118 provides such engagement, which can include virtual interviews, messaging, etc.

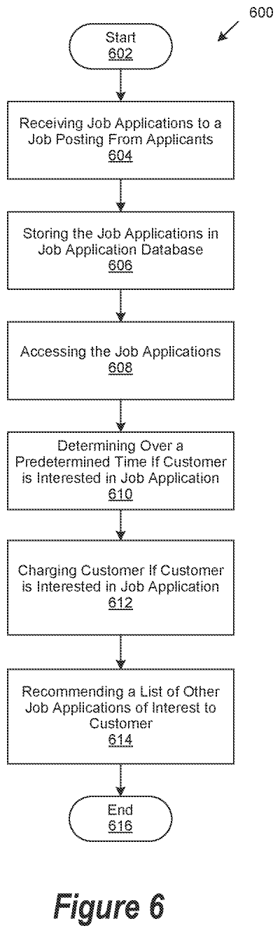

FIG. 6 shows a generalized flowchart for charging customers for job applications for job postings by the customers The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 602, the process 600 starts. The process starts by client(s)/employer(s) 116 accessing through user interface(s) 118 the service 102, and particularly job site portal 104. At step 604, the job site portal 104 receives job applications 108 to a job posting 106 from applicant(s) 120. At step 606, the job applications 108 are stored in a job applications database(s) 126 to be accessed by the job site portal 104. At step 608, the stored job applications 108 are accessed by the job site portal 104. At step 610, over a predetermined time period, determining is performed by job site portal 104, if the customer/employer 116 is interested in a job application 108 to the job posting 106. At step 612, charging the customer/employer 116 is performed by the job site portal 104 if the customer/employer 116 is interested in a job application 108. In various implementations, AI/ML engine 110 uses information from accepted and rejected job applications 108 as to specific job postings 106, and determines characteristics of job applications 108 that would be acceptable to a customer/employer 116. Implementations provide for customer/employer 116 to provide specific answers to particular questions, where the answers to processed by the AI/ML engine 110. The AI/ML engine 110 to recommendation engine 112. At step 614, providing by recommendation engine 112 of the job site portal 104, a list of other job applications 108 that are of interest to the customer customer/employer 116.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

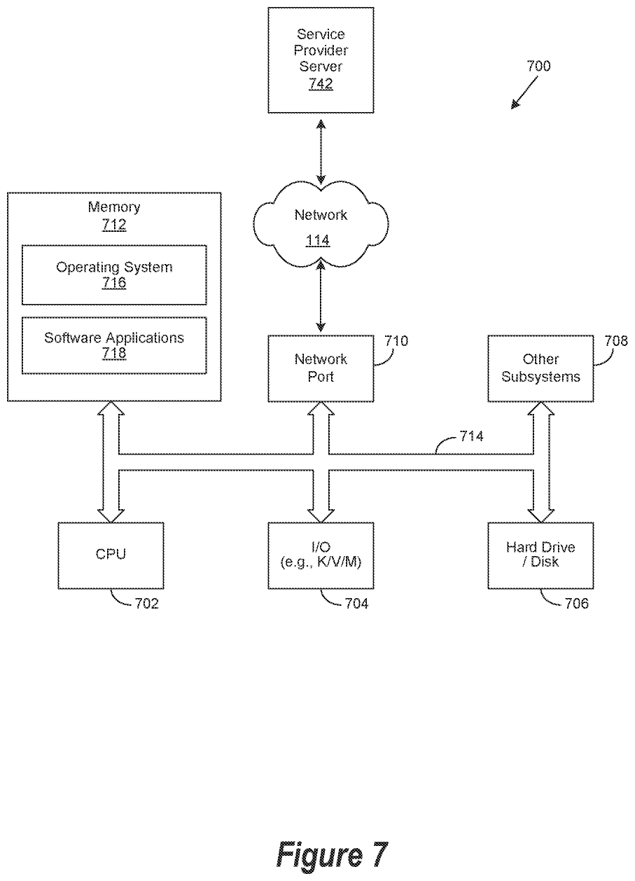

FIG. 7 is a generalized illustration of an information handling system 700 that can be used to implement the system and method of the present invention. The information handing system 700 can be a host to the peripheral devices described herein. As discussed, the information handling system can include a notebook or laptop personal computer (PC) or a PC integrated into a keyboard.

The information handling system 700 includes a processor (e.g., central processor unit or “CPU”) 702, input/output (I/O) devices 704, such as a microphone, a keyboard, a video/display, a mouse, and associated controllers (e.g., K/V/M), a hard drive or disk storage 706, and various other subsystems 708.

In various embodiments, the information handling system 700 also includes network port 710 operable to connect to the network 114, where network 140 can include one or more wired and wireless networks, including the Internet. Network 114 is likewise accessible by a service provider server 742. The information handling system 700 likewise includes system memory 712, which is interconnected to the foregoing via one or more buses 714. System memory 712 can be implemented as hardware, firmware, software, or a combination of such. System memory 712 further includes an operating system (OS) 716. Embodiments provide for the system memory 712 to include power software applications 718, which can perform the methods described herein.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for charging customers as to applicants applying to a job posting comprising:
receiving at a job site portal, job applications to the job posting from the applicants;
storing the job applications in a job application database accessed by the job site portal;
accessing from the job applications database to the job site portal the stored job applications;
determining over a predetermined period of time by the job site portal if a customer is interested in a job application of an applicant to the job posting;
charging by the job site portal the customer, if determined that the customer is interested in the application of the application to the job posting; and
providing by a recommendation engine of the job site portal, a list of other job applications that are of interest to the customer.

2. The computer-implementable method of claim 1, wherein an applicant is kept anonymous from the customer until the customer is charged for a job application by the applicant.

3. The computer-implementable method of claim 1, wherein job applications stored to the job applications database are processed to extract data fields related to applicant information and skills.

4. The computer-implementable method of claim 1 further comprising querying the customer as to reasons job applications are rejected or accepted and applying a ranking algorithm to determine customer preferences to the job application.

5. The computer-implementable method of claim 1 further comprising sending an automated response to candidates whose job applications are rejected.

6. The computer-implementable method of claim 1 further comprising providing a list of potential applicants to the customer for the job posting based on machine learning of job applications rejected and accepted by the customer.

7. The computer-implementable method of claim 1 further comprising providing engagement between the customer and applicants whose job applications are accepted.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for charging customers as to applicants applying to a job posting and comprising instructions executable by the processor and configured for:
receiving at a job site portal, job applications to the job posting from the applicants;
storing the job applications in a job application database accessed by the job site portal;
accessing from the job applications database to the job site portal the stored job applications;
determining over a predetermined period of time by the job site portal if a customer is interested in a job application of an applicant to the job posting;
charging by the job site portal the customer, if determined that the customer is interested in the application of the application to the job posting; and
providing by a recommendation engine of the job site portal, a list of other job applications that are of interest to the customer.

9. The system of claim 8, wherein an applicant is kept anonymous from the customer until the customer is charged for a job application by the applicant.

10. The system of claim 8, wherein job applications stored to the job applications database are processed to extract data fields related to applicant information and skills.

11. The system of claim 8 further comprising sending an automated response to candidates whose job applications are rejected.

12. The system of claim 8 further comprising providing a list of potential applicants to the customer for the job posting based on machine learning of job applications rejected and accepted by the customer.

13. The system of claim 8 further comprising providing a list of potential applicants to the customer for the job posting based on machine learning of job applications rejected and accepted by the customer.

14. The system of claim 8 further comprising monitoring enable and disable points of the one or more PSUs designated as ability to sleep.

15. A non-transitory, computer-readable storage medium embodying computer program code, the computer program code comprising computer executable instructions configured for:
receiving at a job site portal, job applications to the job posting from the applicants;
storing the job applications in a job application database accessed by the job site portal;
accessing from the job applications database to the job site portal the stored job applications;
determining over a predetermined period of time by the job site portal if a customer is interested in a job application of an applicant to the job posting;
charging by the job site portal the customer, if determined that the customer is interested in the application of the application to the job posting; and
providing by a recommendation engine of the job site portal, a list of other job applications that are of interest to the customer.

16. The non-transitory, computer-readable storage medium of claim 15, wherein an applicant is kept anonymous from the customer until the customer is charged for a job application by the applicant.

17. The non-transitory, computer-readable storage medium of claim 15, wherein job applications stored to the job applications database are processed to extract data fields related to applicant information and skills.

18. The non-transitory, computer-readable storage medium of claim 15 further comprising sending an automated response to candidates whose job applications are rejected.

19. The non-transitory, computer-readable storage medium of claim 15 further comprising providing a list of potential applicants to the customer for the job posting based on machine learning of job applications rejected and accepted by the customer.

20. The non-transitory, computer-readable storage medium of claim 15 further comprising providing engagement between the customer and applicants whose job applications are accepted.
